(19) United States
(12) Patent Application Publication
(10) Pub. No.: US 2002/0073269 A1
(43) Pub. Date: Jun. 13, 2002

(54) Data-recording-medium controller, data-recording-medium control method, data-recording apparatus and data-recording-apparatus control unit

(76) Inventors: Hiroshi Kawashima, Kanagawa (JP); Kenichi Saito, Kanagawa (JP); Akira Hayashi, Kanagawa (JP)

Correspondence Address: FROMMER LAWRENCE & HAUG LLP, 745 Fifth Avenue, New York, NY, 10151, US

(21) Appl. No.: 10/021,334

(22) Filed: Dec. 12, 2001

(30) Foreign Application Priority Data
Dec. 13, 2000 (JP) P2000-379429

(51) Int. Cl. G06F 12/00

(52) U.S. Cl. 711/100

(57) ABSTRACT

The memory-stick controller is normally employed in the data-recording apparatus also including an apparatus CPU. First of all, the apparatus CPU issues a BLOCK_READ command to the memory-stick controller and enters a state of waiting for a command-end interrupt to be generated by the memory-stick controller upon completion of execution of the command. The memory-stick controller carries out BLOCK_READ processing on the memory stick in accordance with the BLOCK_READ command. When detecting a processing-end interrupt generated by the memory stick upon completion of execution of the BLOCK_READ processing, the memory-stick controller automatically carries out get-int processing to examine the status of an access to the memory stick. At the end of the get-int processing, the memory-stick controller applies the command-end interrupt to the apparatus CPU. As interrupt handling, the apparatus CPU refers to an interrupt data register to form a judgment as to whether or not a result of the above processing sequence is good. The apparatus CPU also refers to a FIFO for storing a result of the GET_INT processing. Thereafter, the apparatus CPU is capable of carrying out normal processing on the memory stick. The processing includes an operation to store data into the memory stick.

### BACKGROUND OF THE INVENTION

The present invention relates to a data-recording-medium controller and a data-recording-medium control method, which simplify execution of control of a data recording medium having a shape of a small card accommodating a semiconductor storage device such as a memory stick for recording desired data, relates to a data-recording apparatus for recording the desired data into the data recording medium and relates to a data-recording apparatus control unit.

With progress in semiconductor technologies, a memory card with a large storage capacity and a small size has been becoming very popular in a very short period of time, and the number of apparatuses using such a small-size memory card has been increasing.

A recording medium known as the so-called memory stick is a type of such small-size memory card and a sort of widely used data recording medium.

The memory stick includes a flash memory for storing data and a buffer memory for temporarily storing data during use of the memory stick. To be more specific, when data stored in the memory stick is processed, the data is temporarily stored in the buffer memory to be updated or deleted and data to be newly stored into the memory stick is written into the buffer memory. When the data processing sequence is completed, data stored in the buffer memory is written back to the flash memory. Data stored in the flash memory is not deleted but sustained as it is even if application of a power supply to the memory stick is discontinued.

When the memory stick having such a configuration is mounted on a data-recording apparatus such as an electronic still camera, first of all, data is transferred from the flash memory to the buffer memory so that the data is transparent to the data-recording apparatus in update and read operations.

In the conventional data-recording apparatus exchanging data with a data recording medium such as a memory stick, however, a CPU employed in the apparatus must control processing to write and read out data into and from the memory stick from time to time. That is to say, the CPU must carry out all kinds of processing to make accesses to the memory stick.

Examples of the processing to make accesses to the memory stick are a BLOCK_READ operation to issue a command to transfer data from the flash memory to the buffer memory, an SIF-detection operation to detect the end of a data transfer and a GET_INT operation to form a judgment as to whether or not an access to the flash memory has been completed normally.

For this reason, there is raised a problem that the CPU employed in the conventional data-recording apparatus needs to carry out various kinds of other processing and, in addition, since the CPU must execute control of the processing through a system bus, it takes time to complete the processing sequence. That is to say, in the conventional data-recording apparatus, an actual access to the memory stick cannot be made before a long time has lapsed since an operation to mount the memory stick onto the apparatus.

In addition, since the CPU must execute such detailed control from time to time, the processing load borne by the CPU increases, causing a problem that the CPU is not capable of efficiently carrying out processing supposed to be executed.

Furthermore, as described above, control of the memory stick is extremely cumbersome work. Thus, development of a program to be executed by the CPU employed in the conventional data-recording apparatus is also a very troublesome job. For this reason, there is raised a demand for easy control of the memory stick by execution of a simple program.

### SUMMARY OF THE INVENTION

It is thus an object of the present invention addressing the problems described above to provide a data recording medium controller capable of controlling a data recording medium properly or more easily and capable of executing fast control by entailing only a small processing load.

It is another object of the present invention to provide a data-recording apparatus capable of recording data with a higher degree of efficiency into a data recording medium by controlling the data recording medium properly or more easily and executing fast control by entailing only a small processing load.

It is a further object of the present invention to provide a data-recording apparatus control unit capable of controlling peripheral devices of the data-recording apparatus more easily and capable of executing fast control by entailing only a small processing load.

In order to solve the problems described above, in accordance with an aspect of the present invention, there is provided a data recording medium controller for controlling operations of a data recording medium connected to the controller on the basis of an instruction received from a control unit, the controller including a first command means for issuing a first command to the data recording medium to carry out first processing based on the instruction received from the control unit as a command to execute the instruction, a first end-detecting means for detecting a first signal output by the data recording medium to indicate an end of the first processing based on the instruction, a second command means for issuing a second command upon detection of the first signal indicating the end of the first processing to the data recording medium to carry out second processing based on the instruction, a second end-detecting means for detecting a second signal output by the data recording medium to indicate an end of the second processing based on the instruction and a response means for outputting a predetermined response signal upon detection of the second signal indicating the end of the second processing to the control unit in response to the command to execute the instruction.

To be more specific, the data recording medium may include a first memory for storing and holding desired data and a second memory for temporarily storing data to be written into the first memory and data read out from the first memory and the first processing is predetermined processing carried out to make an access to the first memory while the second processing is determination processing carried out to form a judgment as to whether or not an access to the first memory has been made properly.

To be even more specific, the first processing may be processing to transfer data from the first memory to the second memory or data from the second memory to the first memory.

Preferably, there is further provided an instruction storage means for storing the instruction output by the control unit to specify the first processing to be carried out by a predetermined apparatus and, if necessary, the second processing to be carried out by the predetermined apparatus, the first command means gives the first command to the predetermined apparatus to carry out the first processing specified by the instruction stored in the instruction storage means as a command to execute the instruction received from the control unit and the second command means gives the second command upon detection of the first signal indicating the end of the first processing to the predetermined apparatus to carry out the second processing specified by the stored instruction.

More preferably, the first end-detecting means may detect the first signal indicating an end of the first processing as an interrupt signal output by the data recording medium and the second end-detecting means detects the second signal indicating an end of the second processing as an interrupt signal output by the data recording medium.

In accordance with another aspect of the present invention, there is provided a data recording medium control method for controlling operations of a data recording medium adopting the control method on the basis of an instruction received from a control unit, the control method including the steps of issuing a first command to the data recording medium to carry out first processing based on the instruction received from the control unit as a command to execute the instruction, detecting a first signal output by the data recording medium to indicate an end of the first processing based on the instruction, issuing a second command upon detection of the first signal indicating the end of the first processing to the data recording medium to carry out second processing based on the instruction, detecting a second signal output by the data recording medium to indicate an end of the second processing based on the instruction and outputting a predetermined response signal upon detection of the second signal indicating the end of the second processing to the control unit in response to the command to execute the instruction.

In accordance with a further aspect of the present invention, there is provided a data-recording apparatus including a processing means for carrying out any arbitrary data processing, an interface means on which a data recording medium is to be mounted and a data-recording-medium controller for controlling operations of the data recording medium mounted on the interface means on the basis of an instruction issued by the processing means wherein the data-recording-medium controller includes a first command means for issuing a first command to the data recording medium to carry out first processing based on the instruction received from the processing means as a command to execute the instruction, a first end-detecting means for detecting a first signal output by the data recording medium to indicate an end of the first processing based on the instruction, a second command means for issuing a second command upon detection of the first signal indicating the end of the first processing to the data recording medium to carry out second processing based on the instruction, a second end-detecting means for detecting a second signal output by the data recording medium to indicate an end of the second processing based on the instruction and a response means for outputting a predetermined response signal upon detection of the second signal indicating the end of the second processing to the control unit in response to the command to execute the instruction.

In accordance with a still further aspect of the present invention, there is provided data-recording-apparatus control unit for controlling operations carried out by an apparatus connected to the data-recording-apparatus control unit on the basis of an instruction issued by a control unit, the data-recording-apparatus control unit including an instruction storage means for storing the instruction output by the control unit to specify first processing to be carried out by the apparatus and, if necessary, second processing to be carried out by the apparatus, a first command means for giving a command to the apparatus to carry out the first processing specified by the instruction stored in the instruction storage means as a command to execute the instruction received from the control unit and a first end-detecting means for detecting a first signal output by the apparatus to indicate an end of the first processing based on the instruction, a second command means for giving a command upon detection of the first signal indicating the end of the first processing to the apparatus to carry out the second processing specified by the stored instruction, a second end-detecting means for detecting a second signal output by the apparatus to indicate an end of the second processing based on the stored instruction and a response means for outputting a predetermined response signal upon detection of the second signal indicating the end of the second processing to the control unit in response to the command to execute the instruction.

The above and other objects, features and advantages of the present invention will become apparent from the following description and the appended claims, taken in conjunction with the accompanying drawings in which like parts or elements denoted by like reference symbols

### BRIEF DESCRIPTION OF THE DRAWINGS

FIG. 1 is a block diagram showing the configuration of a data-recording apparatus implemented by a first embodiment of the present invention;

FIG. 2 shows a flowchart representing operations carried out by an apparatus CPU and a memory-stick controller, which are both employed in the data-recording apparatus shown in FIG. 1, at the start of an access to data stored in a memory stick also employed in the data-recording apparatus;

FIG. 3 is a block diagram showing the configuration of a data-recording apparatus implemented by a second embodiment of the present invention;

FIGS. 4A through 4C are diagrams showing a map of registers employed in a memory-stick controller of the data-recording apparatus shown in FIG. 3 and used for controlling processing carried out by the memory-stick controller as well as showing the configurations of some of the registers; and

FIG. 5 shows a flowchart representing operations carried out by the memory-stick controller and an apparatus CPU also employed in the data-recording apparatus shown in FIG. 3, at the start of an access to data stored in a memory stick also employed in the data-recording apparatus.

### DETAILED DESCRIPTION OF THE PREFERRED EMBODIMENTS

First Embodiment

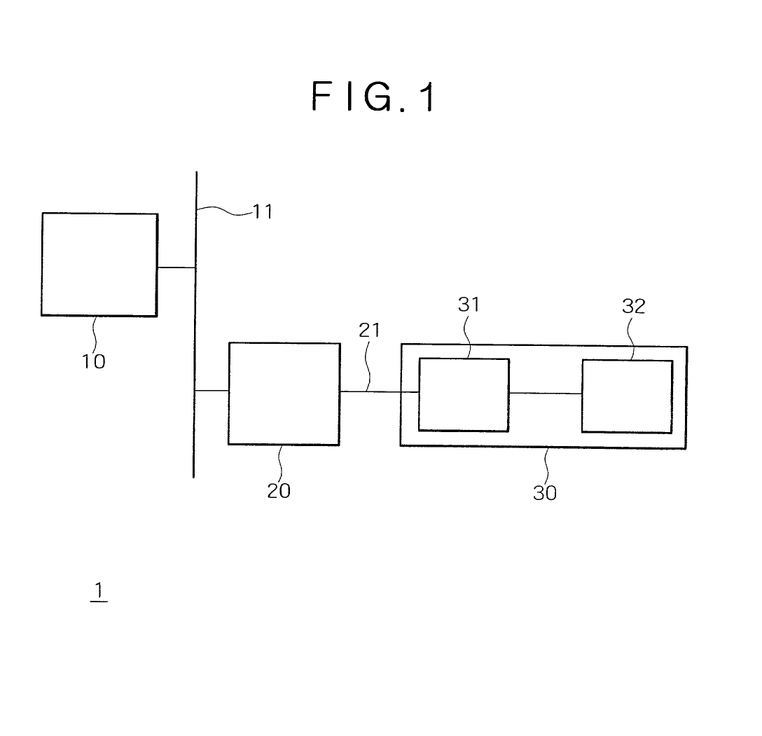

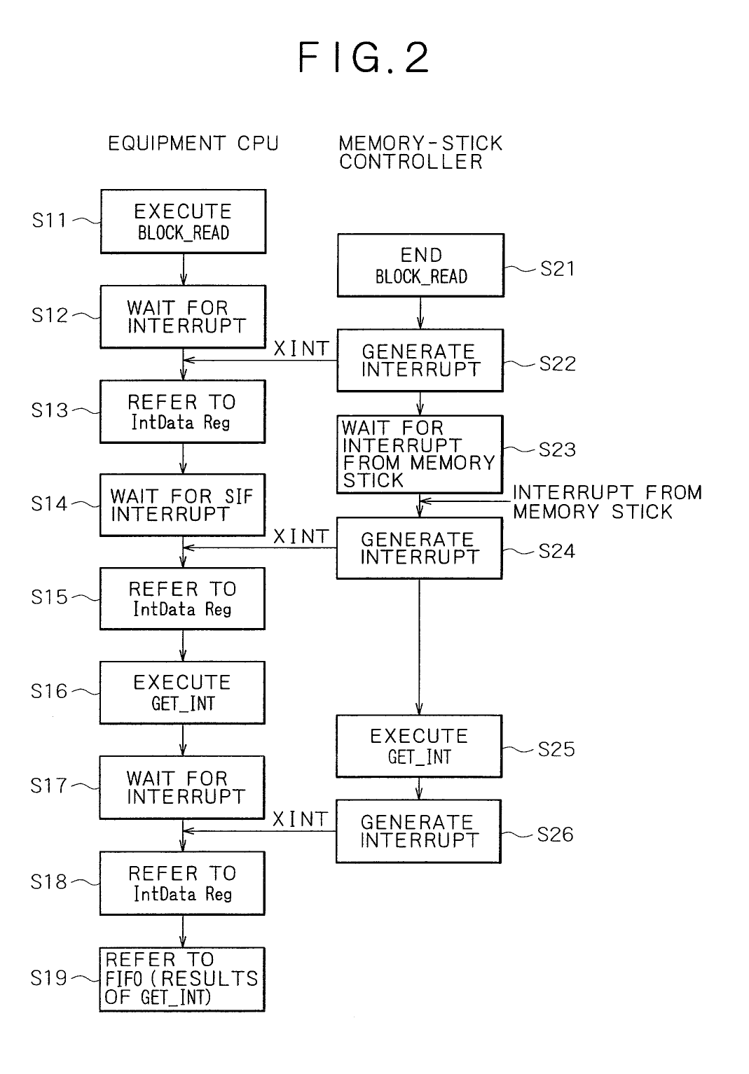

A data-recording apparatus implemented by a first embodiment of the present invention is explained by referring to FIGS. 1 and 2.

The data-recording apparatus implemented by the first embodiment of the present invention records desired data onto a memory stick mounted on the apparatus. An example of the data-recording apparatus is an electronic still camera. In this case, digital picture data obtained as a result of photographing is stored in the memory stick.

First of all, the configuration of the data-recording apparatus 1 implemented by the first embodiment is explained by referring to FIG. 1. FIG. 1 is a block diagram showing the configuration of a data-recording unit employed in the data-recording apparatus. As shown in the figure, the data-recording apparatus 1 includes an apparatus CPU 10, a bus 11, a memory-stick controller 20, a serial bus 21 and a memory stick 30.

The apparatus CPU 10 controls components employed in the data-recording apparatus 1 so that the data-recording apparatus 1 as a whole carries out a desired operation. In particular, operations that are related to the present invention and carried out by the apparatus CPU 10 include various kinds of processing executed on the memory stick 30 mounted on the data-recording apparatus 1.

To put it concretely, for example, the apparatus CPU 10 gives a command to the memory-stick controller 20 to carry out BLOCK_READ processing to transfer data stored in a flash ROM 32 employed in the memory stick 30 to a buffer memory 31 also employed in the memory stick 30 prior to an operation to write data or read out data into and from the memory stick 30.

In addition, when an operation to write data or read out data into and from the flash ROM 32 employed in the memory stick 30 is completed, the apparatus CPU 10 gives a command to the memory-stick controller 20 to carry out BLOCK_WRITE processing to transfer data most recently stored in the buffer memory 31 to the flash ROM 32.

Furthermore, after an operation is carried out on the flash ROM 32 of the memory stick 30, the apparatus CPU 10 gives a command to the memory-stick controller 20 to carry out GET_INT processing to form a judgment as to whether or not an access to the flash ROM 32 of the memory stick 30 has been made normally in the operation.

The apparatus CPU 10 detects a result of the above processing carried out in accordance with a command given by the apparatus CPU 10 or detects a signal indicating an end of the processing in the form of an interrupt generated by the memory-stick controller 20. Detecting an interrupt signal generated by the memory-stick controller 20, the apparatus CPU 10 refers to an interrupt data register named IntDataReg to form a judgment as to whether or not the processing preceding the interrupt signal has been carried out normally before starting next processing.

The bus 11 is a main CPU bus of the data-recording apparatus 1. The bus 11 is used in transfers of various kinds of data and a variety of control signals between the apparatus CPU 10 and a variety of configuration units employed in the data-recording apparatus 1 or between the configuration units themselves, which are not shown in the figure. The bus 11 is used also in transferring various kinds of data and a variety of control signals between the apparatus CPU 10 and the memory-stick controller 20. To be more specific, the apparatus CPU 10 writes data into the memory stick 30 and reads out data from the memory stick 30 through the bus 11.

The memory-stick controller 20 controls the memory stick 30 mounted on the data-recording apparatus 1 on the basis of a control signal output by the apparatus CPU 10 or a command also issued by the apparatus CPU 10.

Basically, the memory-stick controller 20 converts a command received from the apparatus CPU 10 into a signal having a form proper for application to the memory stick 30. The signal is supplied to the memory stick 30 through the serial bus 21 to control the memory stick 30. On the other hand, the memory-stick controller 20 generates a response signal for the apparatus CPU 10 if necessary on the basis of a signal output by the memory stick 30, an operating state and other factors, supplying the response signal to the apparatus CPU 10 through the bus 11.

In order to carry out the operations described above, the memory-stick controller 20 performs various kinds of processing such as processing to decode an address output by the apparatus CPU 10, processing to decode a command issued by the apparatus CPU 10, parallel-to-serial conversion of data, serial-to-parallel conversion of data, generation of a clock signal applied to the memory stick 30, generation of an interrupt signal to be supplied to the apparatus CPU 10, detection of an error and control of transfers of data between the memory stick 30 through the serial bus 21.

The serial bus 21 is a bus through which signals are exchanged between the memory-stick controller 20 and the memory stick 30 mounted on the data-recording apparatus 1.

Desired data is recorded into and read out from a semiconductor memory recording medium in a form of a small-sized card, which is mounted removably on the data-recording apparatus 1 to serve as the memory stick 30, through the serial bus 21 in accordance with control executed by the memory-stick controller 20. As shown in the figure, the memory stick 30 includes the buffer memory 31 and the flash ROM 32 as implicitly described earlier.

The buffer memory 31 is a buffer to which data stored in the flash ROM 32 is transferred temporarily in an operation to read out the data from the memory stick 30 mounted on the data-recording apparatus 1. To put it in detail, in an operation to read out data from the memory stick 30, the memory-stick controller 20 transfers the data to the buffer memory 31 to be eventually output from the memory stick 30. In an operation to write data onto the memory stick 30, on the other hand, the data is written into the buffer memory 31 to be eventually stored in the memory stick 30 at a later time.

The flash ROM 32 is a memory for actually retaining data stored in the memory stick 30. The flash ROM 32 is a non-volatile memory capable of retaining data stored therein even if the memory stick 30 is dismounted from the data-recording apparatus 1, being put in a state with no power supplied thereto.

At the time the memory stick 30 having such a configuration is mounted on the data-recording apparatus 1, data stored in the flash ROM 32 is transferred temporarily to the buffer memory 31 as described earlier. The operation to temporarily transfer data from the flash ROM 32 to the buffer memory 31 is generally referred to as BLOCK_READ processing.

As described above, the memory-stick controller 20 reads out the data transferred to the buffer memory 31 and writes new data into the buffer memory 31 to update transferred data.

At the time the use of the memory stick 30 is ended, newest data stored in the buffer memory 31 is written back to the flash ROM 32 so that all the data including the newest data is retained in the flash ROM 32 even if the power supply is turned off. The operation to write back data from the buffer memory 31 to the flash ROM 32 is generally referred to as BLOCK_WRITE processing

Next, the operation of the data-recording apparatus 1 having such a configuration is explained by referring to a flowchart shown in FIG. 2.

To be more specific, the next description explains a processing sequence carried out by the data-recording apparatus 1 at the start of an access to data stored in the memory stick 30.

FIG. 2 shows a flowchart representing operations carried out by the apparatus CPU 10 and the memory-stick controller 20, which are both employed in the data-recording apparatus 1, at the start of an access to data stored in the memory stick 30.

As shown in the figure, the flowchart begins with a step S11 at which the apparatus CPU 10 employed in the data-recording apparatus 1 issues a BLOCK_READ command to the memory-stick controller 20 when the memory stick 30 is mounted onto the data-recording apparatus 1. Then, at the next step S12, the apparatus CPU 10 enters a state of waiting for an interrupt to be generated by the memory-stick controller 20.

In the mean time, at a step S21, the memory-stick controller 20 converts the command received from the apparatus CPU 10 into serial command data which can be executed by the memory stick 30 and supplies the serial command data to the memory stick 30 in order to carry out the BLOCK_READ processing. The memory stick 30 then starts to transfer data specified in the serial command from the flash ROM 32 to the buffer memory 31.

Then, at the next step S22, at the end of the operation to supply the serial command data to the memory stick 30, the memory-stick controller 20 outputs an interrupt signal to the apparatus CPU 10 to inform the apparatus CPU 10 that the operation has been completed. Subsequently, at the next step S23, the memory-stick controller 20 enters a state of waiting for an interrupt indicating the end of the BLOCK_READ processing to be generated by the memory stick 30.

At the time the apparatus CPU 10 receives the interrupt signal generated by the memory-stick controller 20, the flow of the processing goes on to a step S13 at which the apparatus CPU 10 refers to the interrupt-data register (IntData Reg) to form a judgment as to whether or not the BLOCK_READ command has been normally executed. If the BLOCK_READ command has been normally executed, the flow of the processing goes on to a step S14 at which the apparatus CPU 10 again enters a state of waiting for an SIF interrupt to be generated by the memory-stick controller 20. The SIF interrupt is an interrupt for informing the apparatus CPU 10 that the actual processing of BLOCK_READ has been ended.

In the mean time, after data being read out is transferred from the flash ROM 32 to the buffer memory 31 in the memory stick 30, the memory stick 30 generates the interrupt for notifying the memory-stick controller 20 that such a data transfer has been completed. Then, at the step S24, the memory-stick controller 20 outputs an SIF interrupt signal based on the notice received from the memory stick 30 to the apparatus CPU 10.

Receiving the SIF interrupt signal from the memory-stick controller 20, the apparatus CPU 10 again refers to the interrupt data register (IntData Reg) to form a judgment as to whether or not the BLOCK_READ processing has been ended normally at the next step S15.

If the BLOCK_READ processing has been ended normally, the flow of the processing goes on to a step S16 at which the apparatus CPU 10 issues a GET_INT command to the memory-stick controller 20 to form a judgment as to whether or not the access to the flash ROM 32 in the memory stick 30 has been made normally. Then, at the next step S17, the apparatus CPU 10 again enters a state of waiting for an interrupt to be generated by the memory-stick controller 20.

In the mean time, at a step S25, the memory-stick controller 20 carries out GET_INT processing based on the GET_INT command received from the apparatus CPU 10. When the GET_INT processing is ended, the flow of the processing goes on to a step S26 at which an interrupt signal is output to the apparatus CPU 10 to inform the apparatus CPU 10 that the GET_INT processing has been ended.

When the apparatus CPU 10 receives the interrupt signal output by the memory-stick controller 20 to inform the apparatus CPU 10 that the GET_INT processing has been ended, the flow of the processing goes on to a step S18 at which the apparatus CPU 10 refers to the interrupt data register (IntData Reg) to form a judgment as to whether or not the access to the flash ROM 32 in the memory stick 30 has been made normally and to clear the bit of the register for this interrupt. Then, at the next step S19, the apparatus CPU 10 refers to a FIFO for storing a result of the GET_INT processing.

After the processing described above has been carried out, the apparatus CPU 10 carries out an operation to write or read out desired data into or from the memory stick 30 through the memory-stick controller 20. As a result of the write operation, the desired data is stored in the buffer memory 31. As a result of the read operation, the desired data stored in the buffer memory 31 is read out from the memory stick 30.

When a processing sequence carried out on the memory stick 30 is completed, the apparatus CPU 10 carries out BLOCK_WRITE processing on the memory stick 30. The BLOCK_WRITE processing is similar to the BLOCK_READ-processing sequence represented by the flowchart shown in FIG. 2 except that the apparatus CPU 10 issues a BLOCK_WRITE command in place of the BLOCK_READ command and data is transferred from the buffer memory 31 to the flash ROM 32.

After the BLOCK_WRITE processing has been completed, the memory stick 30 can be dismounted from the data-recording apparatus 1.

By carrying out the processing described above in such a configuration, the apparatus CPU 10 employed in the data-recording apparatus 1 is capable of recording desired data into the memory stick 30 and reading out desired data from the memory stick 30.

Second Embodiment

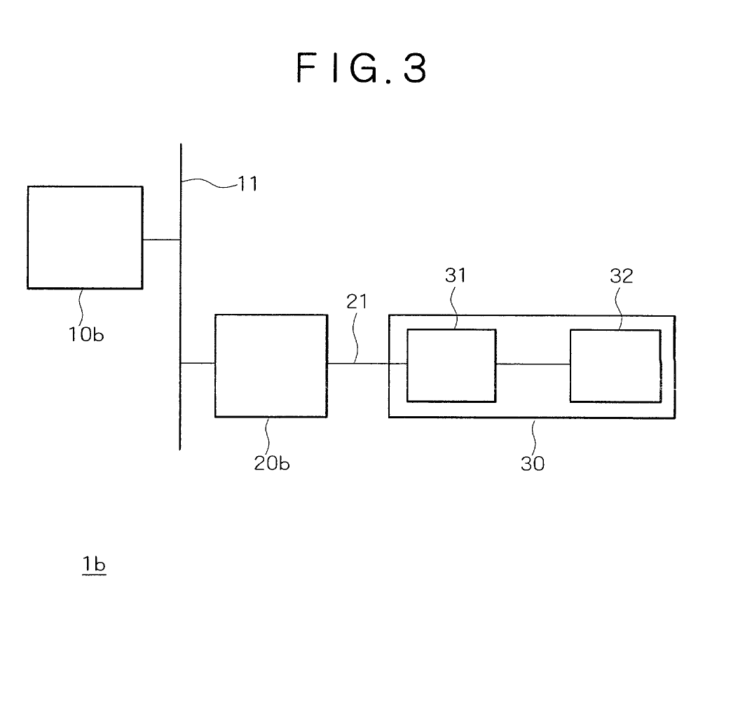

A data-recording apparatus implemented by a second embodiment of the present invention is explained by referring to FIGS. 3 to 5.

Much like the first embodiment, the data-recording apparatus implemented by the second embodiment of the present invention records desired data onto a memory stick mounted on the apparatus. An example of the data-recording apparatus is an electronic still camera.

In order to make an access to the memory stick 30 mounted on the data-recording apparatus 1, in the first embodiment, the apparatus CPU 10 must control the memory-stick controller 20 sequentially, prolonging the time to the actual access to the memory stick 30.

In addition, when writing a control program for the apparatus CPU 10, the programmer must understand a difficult procedure like the one represented by the flowchart shown in FIG. 2. As a result, the first embodiment is difficult to use due to complexity of the programming work.

Furthermore, the apparatus CPU 10 enters a state of waiting for an interrupt 3 times during the processing sequence. To be more specific, the apparatus CPU 10 enters a state of waiting for a response to a BLOCK_READ command after issuing the command, a state of waiting for an SIF interrupt indicating the end of an access to the flash ROM 32 and a state of waiting for a response to a GET_INT command after issuing the command. Such wait states tend to lower the processing efficiency of the apparatus CPU 10.

In order to solve these problems, the present invention provides the second embodiment implementing a processing method for the memory stick 30 and implementing a data-recording apparatus adopting the processing method to shorten the access time, to make programs easy to develop and to reduce the processing load borne by the apparatus CPU 10.

First of all, the configuration of the data-recording apparatus 1b implemented by the second embodiment is explained. FIG. 3 is a block diagram showing the configuration of a data-recording unit employed in the data-recording apparatus shown in the figure, the data-recording apparatus 1b includes an apparatus CPU 10b, a bus 11, a memory-stick controller 20b, a serial bus 21 and a memory stick 30.

The configuration of the data-recording apparatus 1b implemented by the second embodiment is basically the same as the configuration of the data-recording apparatus 1 implemented by the first embodiment as shown in FIG. 1. However, the functions of the apparatus CPU 10b and the memory-stick controller 20b are different from those of the apparatus CPU 10 and the memory-stick controller 20 respectively, which are employed in the first embodiment.

For this reason, the following description explains only differences between the functions of the apparatus CPU 10b and the memory-stick controller 20b and those of the apparatus CPU 10 and the memory-stick controller 20 respectively The description of functions common to the apparatus CPU 10b and the apparatus CPU 10, functions common to the memory-stick controller 20b and the memory-stick controller 20 and the functions of the other components is not repeated.

Prior to an operation to actually write data into the memory stick 30 or read out data from the memory stick 30, the apparatus CPU 10b requests the memory-stick controller 20b to carry out BLOCK_READ processing to transfer data from the flash ROM 32 employed in the memory stick 30 to the buffer memory 31 also employed in the memory stick 30. Upon completion of an operation to actually write data into the memory stick 30 or read out data from the memory stick 30, on the other hand, the apparatus CPU 10b requests the memory-stick controller 20b to carry out BLOCK_WRITE processing to write back newest data stored in the buffer memory 31 to the flash ROM 32.

After the BLOCK_READ processing or the BLOCK_WRITE processing, the apparatus CPU 10b needs to wait only once for an interrupt signal generated by the memory-stick controller 20b in response to a command requesting the execution of the BLOCK_READ processing or the BLOCK_WRITE processing, and then refers to the interrupt data register (IntData Reg) to form a judgment as to whether or not the processing has been carried out normally. In this way, the apparatus CPU 10b ends the BLOCK_READ processing or the BLOCK_WRITE processing prior to the use of the memory stick 30 and the processing carried out upon completion of the use of the memory stick 30, returning to normal operations.

The memory-stick controller 20b controls the memory stick 30 mounted on the data-recording apparatus 1b in accordance with a control signal or a command received from the apparatus CPU 10b. In the particular case of the configuration of the second embodiment, virtually, a plurality of pieces of processing can be carried out for an instruction issued by the apparatus CPU 10b.

The configuration of the memory-stick controller 20b for carrying out such processing is described in detail as follows.

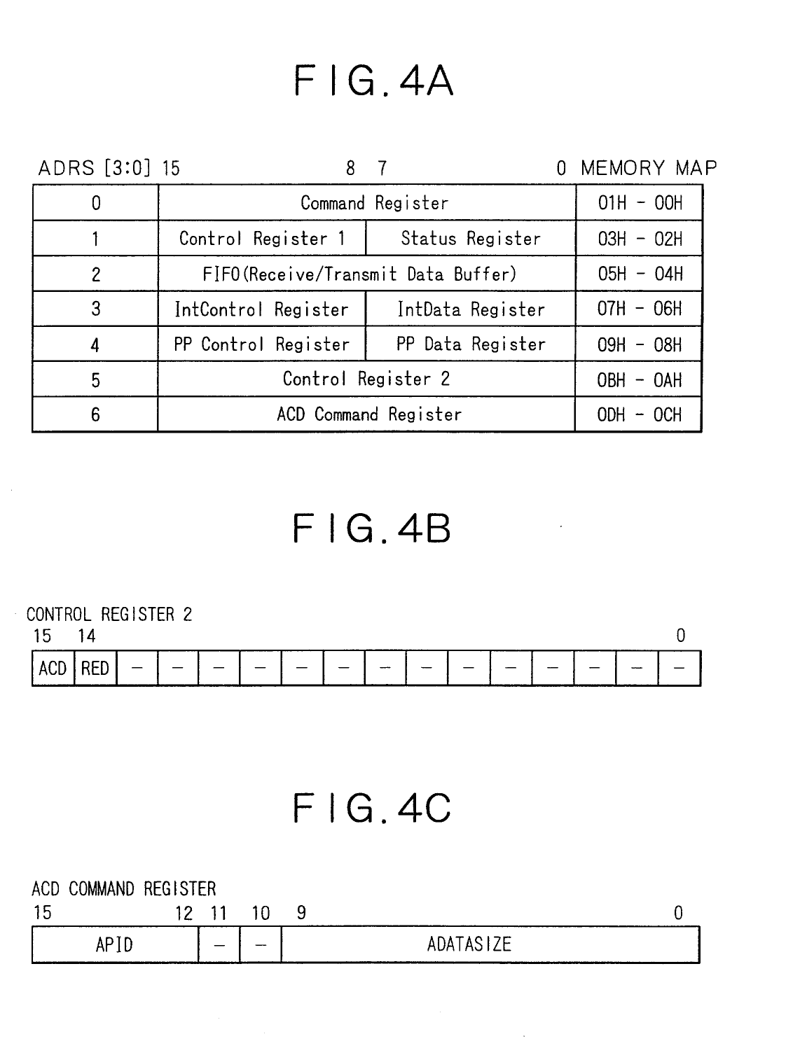

FIG. 4 is a diagram showing a map of registers employed in the memory-stick controller 20b and used for controlling processing carried out by the memory-stick controller 20b as well as showing the configurations of some of the registers.

As shown in FIG. 4A, the memory-stick controller 20b employs an ordinary command register, a first control register, a status register, a FIFO for passing pieces of data, an interrupt control register, an interrupt data register, a PP control register, a PP data register, a second control register and an ACD command register. The apparatus CPU 10b sets desired conditions in some of the registers so that the memory-stick controller 20b carries out desired processing. In addition, the memory-stick controller 20b informs the apparatus CPU 10b of data representing a result of processing or status of processing through some of the registers.

As shown in FIG. 4B, bit 15 serving the MSB (most significant bit) of the second control register employed in the memory-stick controller 20b is a control bit named ACD. The ACD control bit is used as follows. A value of 1 set in the ACD control bit indicates that a command stored in the ACD command register be subsequently executed upon detection of an interrupt signal generated by the memory stick 30. On the other hand, a value of 0 set in the ACD control bit indicates that no subsequent processing is to be carried out.

As shown in FIG. 4C, the ACD command register includes an APID field and an ADATASIZE field. The APID field describes the TPC code of a command to be automatically executed. On the other hand, the ADATASIZE field specifies a data size for the TPC code.

Thus, by setting bit 15 of the second control register at 1 and setting a desired command in the ACD command register, a command issued by the apparatus CPU 10b causes actually 2 pieces of processing to be carried out.

By using this function, the memory-stick controller 20b is capable of carrying out the GET_INT processing on the memory stick 30 upon reception of the SIF interrupt signal from the memory stick 30 without waiting for a GET_INT command to be generated by the apparatus CPU 10b.

In the memory-stick controller 20b implemented by the second embodiment, by such a set of registers and a decoder, it is possible to carry out pieces of processing consecutively.

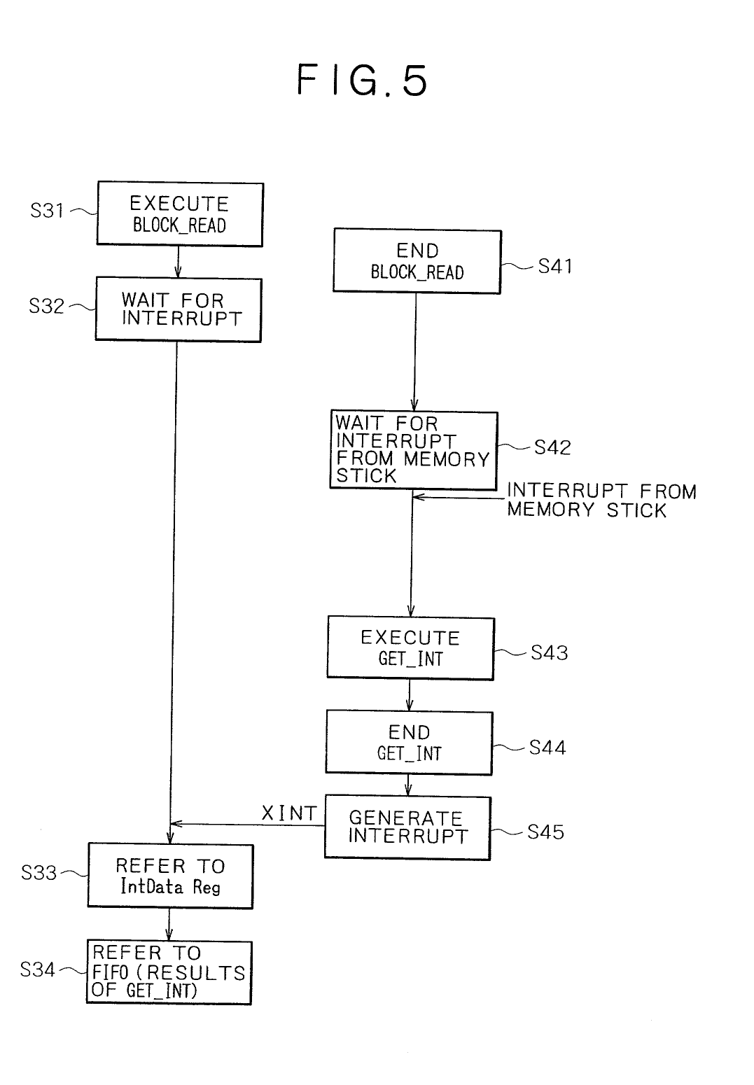

The operation of the data-recording apparatus 1b having such a configuration is explained by referring to a flowchart shown in FIG. 5.

FIG. 5 shows a flowchart representing operations carried out by the apparatus CPU 10b and the memory-stick controller 20b at a start of an access to data stored in the memory stick 30 mounted on the data-recording apparatus 1b.

As shown in the figure, the flowchart begins with a step S31 when the memory stick 30 is mounted on the data-recording apparatus 1b. At the step S31, the apparatus CPU 10b issues a BLOCK_READ command to the memory-stick controller 20b to request the memory-stick controller 20b to carry out BLOCK_READ processing. The flow of the processing then goes on to a step S32 at which the apparatus CPU 10b enters a state of waiting for an interrupt signal to be generated by the memory-stick controller 20b. The apparatus CPU 10b has set the ACD bit of the second control register at 1 and set a GET_INT command in APID field of the ACD command register in advance. The second control register and the ACD command register are shown in FIG. 4.

In the mean time, at a step S41, the memory-stick controller 20b converts the command received from the apparatus CPU 10b into serial command data which can be executed by the memory stick 30 and supplies the serial command data to the memory stick 30 in order to carry out the BLOCK_READ processing. The memory stick 30 then starts to transfer data specified in the serial command from the flash ROM 32 to the buffer memory 31.

Then, at the next step S42, at the end of the operation to supply the serial command data to the memory stick 30, the memory-stick controller 20b enters a state of waiting for an interrupt indicating the end of the access to the flash ROM 32 to be generated by the memory stick 30.

After data being read out is transferred from the flash ROM 32 to the buffer memory 31 in the memory stick 30, the memory stick 30 generates the interrupt for notifying the memory-stick controller 20b that such a data transfer has been completed. Receiving the interrupt signal, the memory-stick controller 20b carries out GET_INT processing at the next step S43 due to the fact that bit 15 of the second control register has been set at 1 beforehand and a GET_INT command has been set in the ACD command register in advance. The GET_INT processing is carried out on the memory stick 30 to form a judgment as to whether or not the access to the flash ROM 32 employed in the memory stick 30 has been made correctly. When the GET_INT processing is ended at the next step S44, the flow of the processing goes on to a step S45 at which an interrupt signal is output to the apparatus CPU 10b to inform the apparatus CPU 10b that the GET_INT processing has been ended.

When the apparatus CPU 10b receives the interrupt signal output by the memory-stick controller 20b to inform the apparatus CPU 10b that the GET_INT processing has been ended, the flow of the processing goes on to a step S33 at which the apparatus CPU 10b refers to the interrupt data register (IntData Reg) to form a judgment as to whether or not the processing sequence has been carried out normally and to clear the bit of the register for this interrupt. Then, at the next step S34, the apparatus CPU 10b refers to a FIFO for storing a result of the GET_INT processing.

After the processing described above has been carried out, the apparatus CPU 10b carries out an operation to write or read out desired data into or from the memory stick 30 through the memory-stick controller 20b. As a result of the write operation, the desired data is stored in the buffer memory 31. As a result of the read operation, the desired data stored in the buffer memory 31 is read out from the memory stick 30.

When a processing sequence carried out on the memory stick 30 is completed, the apparatus CPU 10b carries out BLOCK_WRITE processing on the memory stick 30. The BLOCK_WRITE processing is similar to the BLOCK_READ-processing sequence represented by the flowchart shown in FIG. 5 except that the apparatus CPU 10b issues a BLOCK_WRITE command in place of the BLOCK_READ command and data is transferred from the buffer memory 31 to the flash ROM 32.

As described above, in the data-recording apparatus 1b implemented by the second embodiment, once the apparatus CPU 10b issues a BLOCK_READ command to the memory-stick controller 20b, the memory-stick controller 20b automatically carries out a sequence of operations, namely, BLOCK_READ processing on the memory stick 30, interrupt handling at the end of the access to the flash ROM 32, GET_INT processing on the memory stick 30 and interrupt handling upon completion of the GET_INT processing. Thus, in comparison with the first embodiment wherein the apparatus CPU 10 issues a command for each of the operations sequentially, processing can be carried out at a much higher speed. As a result, the length of time lapsing since the operation to mount the memory stick 30 onto the data-recording apparatus 1b till the actual access can be substantially reduced.

In addition, since the apparatus CPU 10b issues a BLOCK_READ command to the memory-stick controller 20b only once, the control of the memory stick 30 and, hence, the creation of an operation program to be executed by the apparatus CPU 10b employed in the data-recording apparatus 1b can be simplified.

Moreover, since the number of times interrupt processing is carried out by the apparatus CPU 10b and the number of times processing is carried out to issue a command are reduced, the interruption of main processing carried out by the apparatus CPU 10b can be avoided, making it possible to increase the processing efficiency of the apparatus CPU 10b.

Typical Modified Versions

It should be noted that the scope of the present embodiment is not limited to the present embodiments. Instead, a variety of proper changes and appropriate modifications can be made to the embodiments.

In the case of the first and second embodiments of the present invention described above, for example, BLOCK_READ processing is carried out right after the memory stick is mounted onto the data-recording apparatus.

However, the essential of the present invention is the employment of a command register and a decoder, which are like the ones shown in FIG. 4, in the memory-stick controller. In such a configuration, virtually 2 commands based on an instruction issued by the apparatus CPU are executed by the memory-stick controller automatically. Thus, this function can also be applied to control of any arbitrary processing other than BLOCK_READ without regard to the type of the command. It should be noted that the fact that this function can be applied to any arbitrary instruction is also obvious from the configuration of registers shown in FIG. 4.

In addition, while the first and second embodiments described above, each implements an electronic still camera for recording data of a static picture taken as a result of photographing, the present invention can also be applied to any other data-recording apparatuses such as an apparatus for recording a moving picture and an apparatus for recording any data.

Furthermore, while the first and second embodiments described above, each uses the so-called memory stick as a recording medium, the present invention can also be applied to any arbitrary small-size card-type recording medium such as the so-called smart media, a memory card or a multi-media card. Moreover, the scope of the present invention is not limited to card-type recording media, but also includes any data-recording medium.

In addition, the configuration of a command register employed in the memory-stick controller 20b provided by the second embodiment, the names of commands, the configuration of the memory stick, the configuration of the data-recording apparatus and other features are not limited to the embodiments described above. That is to say, they can be changed appropriately.

As described above, in accordance with the present invention, it is possible to provide a data recording medium controller and control method that are capable of properly controlling the data recording medium, that is, controlling the data recording medium more easily and fast by entailing only a small processing load.

Furthermore, it is also possible to provide a data-recording apparatus that is capable of recording data onto a data recording medium with a high degree of efficiency by properly controlling the data recording medium, that is, controlling the data recording medium more easily and fast by entailing only a small processing load.

Moreover, it is also possible to provide a data-recording apparatus control unit that is capable of controlling peripheral units of the data-recording apparatus more easily and fast by entailing only a small processing load.

While a preferred embodiment of the present invention has been described using specific terms, such description is for illustrative purposes only, and it is to be understood that changes and variations may be made without departing from the spirit or scope of the following claims.

What is claimed is:

1. A data recording medium controller for controlling operations of a data recording medium connected to said controller on the basis of an instruction received from a control unit, said controller comprising:
a first command means for issuing a first command to said data recording medium to carry out first processing based on said instruction received from said control unit as a command to execute said instruction;
a first end-detecting means for detecting a first signal output by said data recording medium to indicate an end of said first processing based on said instruction;
a second command means for issuing a second command upon detection of said first signal indicating the end of said first processing to said data recording medium to carry out second processing based on said instruction;
a second end-detecting means for detecting a second signal output by said data recording medium to indicate an end of said second processing based on said instruction; and
a response means for outputting a predetermined response signal upon detection of said second signal indicating the end of said second processing to said control unit in response to said command to execute said instruction.

2. A data recording medium controller according to claim 1 wherein:
said data recording medium comprises a first memory for storing and holding desired data and a second memory for temporarily storing data to be written into said first memory and data read out from said first memory; and
said first processing is predetermined processing carried out to make an access to said first memory while said second processing is determination processing carried out to form a judgment as to whether or not an access to said first memory has been made properly.

3. A data recording medium controller according to claim 2 wherein said first processing is processing to transfer data from said first memory to said second memory or data from said second memory to said first memory.

4. A data recording medium controller according to claim 2 wherein:
there is further provided an instruction storage means for storing said instruction output by said control unit to specify said first processing to be carried out by a predetermined apparatus and, if necessary, said second processing to be carried out by said predetermined apparatus;
said first command means gives said first command to said predetermined apparatus to carry out said first processing specified by said instruction stored in said instruction storage means as a command to execute said instruction received from said control unit; and
said second command means gives said second command upon detection of said first signal indicating the end of said first processing to said predetermined apparatus to carry out said second processing specified by said stored instruction.

5. A data recording medium controller according to claim 4 wherein:
said first end-detecting means detects said first signal indicating an end of said first processing as an interrupt signal output by said data recording medium; and
said second end-detecting means detects said second signal indicating an end of said second processing as an interrupt signal output by said data recording medium.

6. A data recording medium control method for controlling operations of a data recording medium adopting said control method on the basis of an instruction received from a control unit, said control method comprising the steps of:
issuing a first command to said data recording medium to carry out first processing based on said instruction received from said control unit as a command to execute said instruction;
detecting a first signal output by said data recording medium to indicate an end of said first processing based on said instruction;
issuing a second command upon detection of said first signal indicating the end of said first processing to said data recording medium to carry out second processing based on said instruction;
detecting a second signal output by said data recording medium to indicate an end of said second processing based on said instruction; and
outputting a predetermined response signal upon detection of s aid second signal indicating the end of said second processing to said control unit in response to said command to execute said instruction.

7. A data recording medium control method according to claim 6 wherein:
said data recording medium comprises a first memory for storing and holding desired data and a second memory for temporarily storing data to be written into said first memory and data read out from said first memory; and
said first processing is predetermined processing carried out to make an access to said first memory while said second processing is determination processing carried out to form a judgment as to whether or not an access to said first memory has been made properly.

8. A data recording medium control method according to claim 7 wherein said first processing is processing to transfer data from said first memory to said second memory or data from said second memory to said first memory.

9. A data recording medium control method according to claim 6, said control method further comprising the steps of:
storing said instruction output by said control unit to specify said first processing to be carried out by a predetermined apparatus and, if necessary, said second processing to be carried out by said predetermined apparatus;
giving said first command to said predetermined apparatus to carry out said first processing specified by said stored instruction as a command to execute said instruction received from said control unit; and
giving said second command upon detection of said first signal indicating an end of said first processing to said predetermined apparatus to carry out said second processing specified by said stored instruction.

10. A data recording medium control method according to claim 9, said control method further comprising the steps of:
detecting said first signal indicating an end of said first processing as an interrupt signal output by said data recording medium; and
detecting said second signal indicating an end of said second processing as an interrupt signal output by said data recording medium.

11. A data-recording apparatus comprising:
a processing means for carrying out any arbitrary data processing;
an interface means on which a data recording medium is to be mounted; and
a data-recording-medium controller for controlling operations of said data recording medium mounted on said interface means on the basis of an instruction issued by said processing means,
wherein said data-recording-medium controller comprises:
a first command means for issuing a first command to said data recording medium to carry out first processing based on said instruction received from said processing means as a command to execute said instruction;
a first end-detecting means for detecting a first signal output by said data recording medium to indicate an end of said first processing based on said instruction;
a second command means for issuing a second command upon detection of said first signal indicating the end of said first processing to said data recording medium to carry out second processing based on said instruction;
a second end-detecting means for detecting a second signal output by said data recording medium to indicate an end of said second processing based on said instruction; and
a response means for outputting a predetermined response signal upon detection of said second signal indicating the end of said second processing to said control unit in response to said command to execute said instruction.

12. A data-recording-apparatus control unit for controlling operations carried out by an apparatus connected to said data-recording-apparatus control unit on the basis of an instruction issued by a control unit, said data-recording-apparatus control unit comprising:
an instruction storage means for storing said instruction output by said control unit to specify first processing to be carried out by said apparatus and, if necessary, second processing to be carried out by said apparatus;
a first command means for giving a command to said apparatus to carry out said first processing specified by said instruction stored in said instruction storage means as a command to execute said instruction received from said control unit; and
a first end-detecting means for detecting a first signal output by said apparatus to indicate an end of said first processing based on said instruction;
a second command means for giving a command upon detection of said first signal indicating the end of said first processing to said apparatus to carry out said second processing specified by said stored instruction;
a second end-detecting means for detecting a second signal output by said apparatus to indicate an end of said second processing based on said stored instruction; and
a response means for outputting a predetermined response signal upon detection of said second signal indicating the end of said second processing to said control unit in response to said command to execute said instruction.
